(19) United States
(12) Patent Application Publication
(10) Pub. No.: US 2012/0017118 A1
(43) Pub. Date: Jan. 19, 2012

(54) METHOD AND APPARATUS FOR TESTING AN INTEGRATED CIRCUIT INCLUDING AN I/O INTERFACE

(75) Inventors: Shadi Barakat, Foster City, CA (US); Petre Popescu, Ottawa (CA); David Block, Pleasanton, CA (US)

(73) Assignees: ADVANCED MICRO DEVICES, INC., Sunnyvale, CA (US); ATI TECHNOLOGIES ULC, Markham (CA)

(21) Appl. No.: 12/838,860

(22) Filed: Jul. 19, 2010

(51) Int. Cl. G06F 11/263

(52) U.S. Cl. 714/37; 714/E11.177

(57) ABSTRACT

Methods and apparatus provide for testing an integrated circuit including an input/output (I/O) interface. The method and apparatus place the I/O interface in a test mode by test enabling logic. During the test mode, the method and apparatus also provide, by a clock generator in the I/O interface, an internal phase-aligned receiver clock signal to a plurality of transceivers in the I/O interface. The clock generator is a transmitter portion of one of the plurality of transceivers in the I/O interface. The method and apparatus then monitor for errors in loopback data from the plurality of transceivers in the I/O interface by an automatic test equipment (ATE). The phase of the internal phase-aligned receiver clock signal is aligned with the loopback data of the plurality of transceivers, and the frequency of the internal phase-aligned receiver clock signal may be above about 200 MHz.

### BACKGROUND OF THE DISCLOSURE

The disclosure relates generally to methods and apparatus for testing an integrated circuit, and more particularly, to methods and apparatus for testing an integrated circuit including an input/output (I/O) interface.

In an automatic test equipment (ATE) environment, it is difficult to test a data channel of a high-speed I/O interface (e.g. transceiver device) because of the need to generate high-speed data and clock signals, which is not practical for the conventional ATE tester. One way to solve this problem is to use a loopback testing scheme. A loopback test is a diagnostic procedure for a transceiver in which a signal generated from the transmitter portion is received in the corresponding receiver portion, thereby passing through all of the circuits as a way to determine whether the circuits are working properly. The returned signal is compared with the transmitted signal to evaluate the integrity of the circuit, system or transmission path. The high-speed I/O interface generates its own high-speed data that is looped back to the corresponding receivers, such that the ATE only need to monitor a low-speed error output from the high-speed I/O interface.

One technique for performing the high-speed ATE loopback testing is to use relays as switching elements for each transceiver in an I/O interface to switch between the low-speed parametric measurements that require direct connection of the ATE to the I/O interface, and the loopback data stream operating at a high-speed rate. The number of the relays required by this technique dramatically increases as the number of the transceivers in the I/O interface increases. Accordingly, the large number of relays and other additional circuit components, for example, digital to analog (D-A) converters, which are added to the I/O interface, can significantly increase the design complexity, die area, and cost of the I/O interface.

In addition to the high-speed data signal, testing a source-synchronous high-speed I/O interface requires a high-speed clock signal for synchronizing the data signal in a test mode. A known technique to provide the high-speed clock signal is to use a sophisticated and expensive ATE tester with additional external components to generate an external high-speed clock signal and send it to the I/O interface. However, one problem of using the external clock signal from the ATE is that the loopback data signals have to be aligned with the external clock signal during the test.

Accordingly, there exists a need for improved methods and apparatus for testing an integrated circuit including an I/O interface in order to address one or more of the above-noted drawbacks.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of an integrated circuit including an I/O interface, and an ATE in accordance with one embodiment set forth in the disclosure;

FIG. 2 is a block diagram illustrating one example of the I/O interface shown in FIG. 1 during a test mode;

FIG. 3 is a flowchart illustrating one example of a method for testing the integrated circuit including the I/O interface in accordance with one embodiment set forth in the disclosure;

FIG. 4 is a flowchart illustrating another example of a method for testing the integrated circuit including the I/O interface;

FIG. 5 is a detailed diagram of one example of the I/O interface shown in FIG. 1; and

FIG. 6 is a flowchart illustrating of one example of a method for testing the integrated circuit including the I/O interface.

### DETAILED DESCRIPTION OF THE PREFERRED EMBODIMENTS

Briefly, a method and apparatus for testing an integrated circuit including an I/O interface are disclosed. In one example, the method and apparatus place the I/O interface in a test mode by test enabling logic. During the test mode, the method and apparatus also provide, by a clock generator in the I/O interface, an internal phase-aligned receiver clock signal to a plurality of transceivers in the I/O interface. The clock generator is a transmitter portion of one of the plurality of transceivers in the I/O interface. The method and apparatus then monitor for errors in loopback data from the plurality of transceivers in the I/O interface by an ATE. The phase of the internal phase-aligned receiver clock signal is aligned with the loopback data of the plurality of transceivers, and the frequency of the internal phase-aligned receiver clock signal may be above about 200 MHz. The integrated circuit may also include logic operatively connected to the I/O interface, such as a graphic processor, a host processor, a controller or a memory.

The method and apparatus may provide a transmitter clock signal to the plurality of transceivers in the I/O interface. The transmitter clock signal may be distributed uniformly to each one of the plurality of transceivers in the I/O interface through a balanced clock tree. The method and apparatus may also receive, by the clock generator, a clock data pattern. The clock data pattern is generated based on an external control signal from the ATE. In response to the transmitter clock signal, the method and apparatus may further generate, by the clock generator, the internal phase-aligned receiver clock signal based on the clock data pattern. The internal phase-aligned receiver clock signal may also be distributed uniformly to each one of the plurality of transceivers in the I/O interface through a balanced clock tree. The method and apparatus may further transmit test data by a transmitter portion of the plurality of transceivers in the I/O interface; receive the loopback data by a receiver portion corresponding to the transmitter portion of the plurality of transceivers in the I/O interface; and compare the received loopback data with the transmitted test data to determine the errors in the loopback data.

The method and apparatus may also place the I/O interface in a normal mode by the test enabling logic. During the normal mode, the method and apparatus may disable the clock generator in the I/O interface, and provide an external receiver clock signal to the plurality of transceivers in the I/O interface as opposed to the internal phase-aligned receiver clock signal during the test mode.

Among other advantages, the method and apparatus for testing the integrated circuit including the I/O interface provide the ability to perform the loopback testing of high-speed source-synchronous data. The internal phase-aligned receiver clock signal is generated by the clock generator, which is a transmitter portion of one of the internal transceivers in the I/O interface, and is phase-aligned with the loopback data of the transceivers in the I/O interface. In addition, during the test mode, the ATE only needs to send control signals to the I/O interface and monitor for low-speed error data signals from the I/O interface. As the control and error data signals are low-speed signals, conventional ATE environment is suitable for loopback testing of high-speed source-synchronous data. Furthermore, as the transmitter clock signal and the internal phase-aligned receiver clock signal are distributed to each transceiver through balanced clock trees, a less complex or no additional tuning element is required in the I/O interface to ensure the uniformity of the clock signal received by each transceiver. Accordingly, the proposed techniques can reduce the complexity and cost it takes to perform I/O interface testing at the wafer level or die level by the ATE, which is critical for die stacking. Other advantages will be recognized by those of ordinary skill in the art.

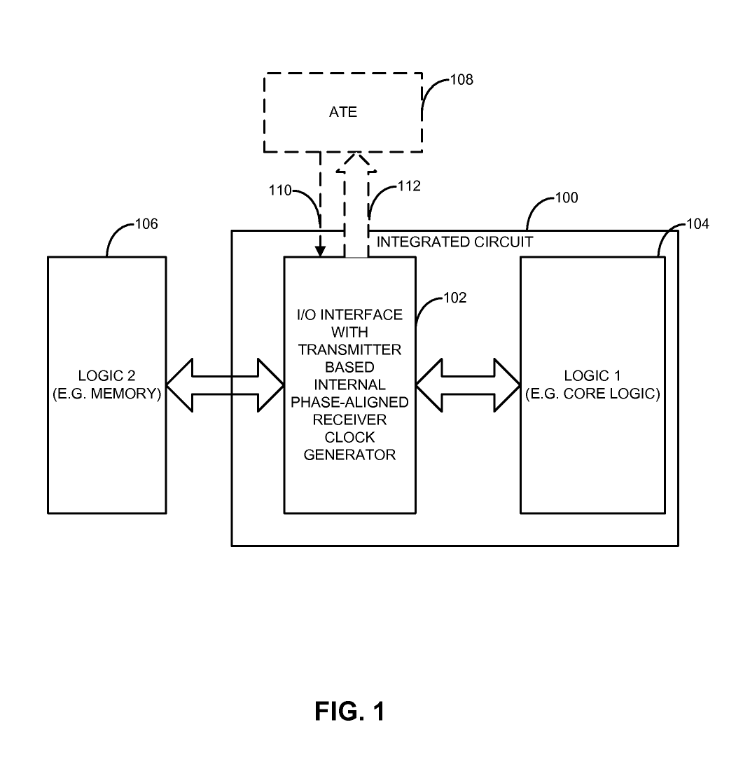

FIG. 1 illustrates one example of an integrated circuit 100 including an I/O interface 102 and first logic (e.g. core logic) 104, second logic 106 operatively connected to the integrated circuit 100 during a normal mode, and an ATE 108 operatively connected to the integrated circuit 100 during a test mode. The integrated circuit 100 may be any suitable circuit that has the I/O interface 102 and the core logic 104 bidirectionally communicating with the I/O interface 102, for example, a graphic processor, a central processing unit (CPU), a system controller, a memory controller or an I/O controller, to name a few. The second logic 106 may include but is not limited to a system memory, a frame buffer or unified memory architecture, which performs bidirectional communication with the integrated circuit 100 via the I/O interface 102. The second logic 106 may also be any suitable logic that interfaces with the I/O interface 102 of the integrated circuit 100. It is understood that, although the second logic 106 in FIG. 1 is shown as a discrete memory off the integrated circuit 100 in this example, the second logic 106 may be integrated on the integrated circuit 100, such as an on-chip cache memory. In this example, the I/O interface 102 includes multiple transceivers that can perform bidirectional and parallel data communication between the first logic 104 and the second logic 106 during the normal mode. In addition, the I/O interface 102 receives control and clock signals from the first logic 104 and/or the second logic 106, and sends control and clock signals to the first logic 104 and/or the second logic 106. Any other suitable circuit or logic known in the art may be included in the integrated circuit 100 as well. In this example, as previously noted, the I/O interface 102 may work in a normal mode or a test mode. During the test mode, the I/O interface 102 is operatively connected to the ATE 108 and may be disconnected with the second logic 106. In this example, the ATE 108 tests the integrated circuit 100 including the I/O interface 102 at the wafer or die level. The ATE 108 may be a simple computer controlled digital multimeter, or a complicated system containing multiple complex test instruments (e.g. real or simulated electronic test equipment) capable of automatically testing and diagnosing faults in sophisticated electronic packaged parts or on wafer testing, including system-on-chips and integrated circuits as known in the art. As shown in FIG. 1, the bidirectional communication between the I/O interface 102 and the ATE 108 during the test mode may include but is not limited to receiving control signals 110 from the ATE 108 and sending serial or parallel error data signals 112 to the ATE 108.

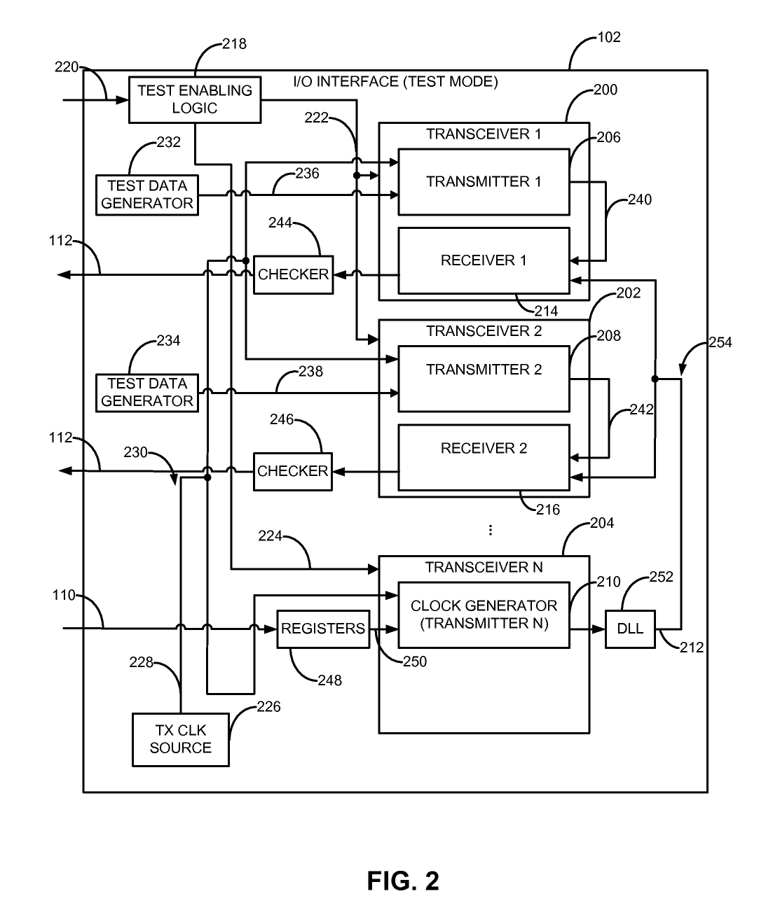

FIG. 2 illustrates one example of the I/O interface 102 in the integrated circuit 100 during the test mode. The I/O interface 102 includes multiple transceivers 200-204, such as a first transceiver 200 and a second transceiver 202. It is noted that the actual number of the transceivers in the I/O interface 102 may be extended, for example, to 64 for a 64 bit I/O interface or may be any suitable size. Each transceiver 200-204 may include a transmitter portion (Tx) 206-210, such as a first transmitter 206 and a second transmitter 208. In particular, one of the transceivers 204 includes a transmitter portion that is used as a clock generator 210 to generate an internal phase-aligned receiver clock signal 212 during the test mode. The internal phase-aligned receiver clock signal 212 is synchronous with the loopback data and used for the sampling of all received loopback data for loopback testing. As the transmitter of any existing transceivers in the I/O interface 102 may be utilized as the clock generator 210 during the test mode, no additional circuit or logic is needed to provide the internal receiver clock signal. In addition, each transceiver 200-204 may include a corresponding receiver portion (Rx), such as a first receiver 214 and a second receiver 216. For loopback testing, the output of each transmitter 206, 208 is connected to the input of its corresponding receiver 214, 216, respectively, to form a closed data path. It is understood that, although the receiver portion of the transceiver 204 is not shown in FIG. 2 as it may be disabled during the test mode and only the transmitter portion of the transceiver 204 is used as the clock generator 210, the receiver portion of the transceiver 204, in another example, may be enabled and used during the test mode to test the circuit of the transceiver 204 for internal clock generation.

As shown in FIG. 2, test enabling logic 218 may be included in the I/O interface 102 to, in response to a test mode control signal 220, switch the I/O interface 102 between the test mode and the normal mode by sending multiple test enabling signals 222, 224 to the transceivers 200-204 (e.g. send the test enabling signal 222 to the first and second transceivers 200, 202, and send the test enabling signal 224 to the transceiver 204). The test mode control signal 220 that indicates the test mode switching may be sent from the ATE 108 or the first logic 104 to the I/O interface 102. In one example, the assertion of the test mode control signal 220 triggers the switching from the normal mode to the test mode, while the de-assertion of the test mode control signal 220 triggers the switching from the test mode to the normal mode. Although the test enabling logic 218 in FIG. 2 is shown as a part of the I/O interface 102, it is understood that the test enabling logic 218 may be separate from the I/O interface 102 and operatively coupled to the I/O interface 102. Any suitable circuit or logic known in the art that can switch the I/O interface 102 between the test mode and the normal mode may be employed as the test enabling logic 218 herein.

Still referring to FIG. 2, the I/O interface 102 includes a transmitter clock source 226 that provides a transmitter clock signal 228 to the transceivers 200-204. In one example, the transmitter clock source 226 is a phase-locked loop (PLL) clock synthesizer that generates an output clock signal whose phase is related to the phase of the input reference clock signal (e.g. system reference clock from the core logic 104 or the memory 106). In another example, the transmitter clock source 226 is a crystal oscillator that provides a stable clock signal. Any other suitable circuit or logic known in the art may be employed as the transmitter clock source 226 herein. In this example, the transmitter clock signal 228 is distributed uniformly to each one of the transceivers 200-204 through a balanced clock tree 230. As shown in FIG. 2, the balanced clock tree 230 may be a binary tree with each transceiver 200-204 as a leaf node, and the connection distances from the transmitter clock source 226 to each leaf node (i.e. transceiver) are substantially equal to each other. As such, the transmitter clock signal 228 arrives at each transceiver 200-204 at approximately the same time. The level of the binary tree is determined by the number of transceivers in the I/O interface 102. The balanced clock tree 230 ensures the minimum clock skew at each one of the transceivers 200-204 with less or no additional tuning element in the I/O interface 102, thereby reducing the design complexity and die area.

As shown in FIG. 2, the I/O interface 102 may also include multiple test data generators 232, 234 operatively connected to the transceivers 200, 202. During the test mode, the test data generators 232, 234 generate test data 236, 238 to each transceiver 200, 202. For example, the test data generators 232, 234 may be linear feedback shift registers (LFSR) based pseudo random binary sequences (PRBS) generators that generate PRBS data as the test data 236, 238. In one example, the I/O interface 102 does not include the test data generators 232, 234, and instead, receive the test data 236, 238 from the integrated circuit 100 directly. In another example, each test data generator 232, 234 is a part of the individual transceivers 200, 202. In this example, the bit rate of the test data 236, 238 may be in a range from about 200 Mbit/s to about 5 Gbit/s to test the high-speed I/O interface 102. During the test mode, in operation, the transceivers 200, 202 operate in a loopback testing scheme. The data path of each transmitter 206, 208 is connected to the data path of its corresponding receiver 214, 216, respectively. As such, the test data 236, 238 is transmitted by the transmitter 206, 208, and the loopback data 240, 242 is received by the corresponding receiver 214, 216, respectively. In particular, the phase of loopback data 240, 242 is aligned with the internal phase-aligned receiver clock signal 212 during the test mode. In this example, each transceiver 200, 202 includes a checker 244, 246 operatively connected to the receiver 214, 216 to determine errors in the loopback data 240, 242 by comparing the received loopback data 240, 242 with the corresponding test data 236, 238 for each transceiver 200, 202. The checkers 244, 246 then send the serial or parallel error data signals 112 to the ATE 108. The bit rate of the error data signals 112 is much lower than the test data 236, 238, and can be stored (latched) waiting for the ATE tester 108 to read (clear on read, for example). In one example, an error counter may be added if desired.

The I/O interface 102 may include registers 248 that provide a clock data pattern 250 to the clock generator 210 in response to the control signal 110 from the ATE 108 or the first logic 104. The registers 248 may be programmed by the ATE 108. The clock generator 210 then generates the internal phase-aligned receiver clock signal 212 based on the received transmitter clock signal 228 and the clock data pattern 250. The phase of the internal phase-aligned receiver clock signal 212 is shifted 90 degrees from the transmitter clock signal 228 by a delay-locked loop (DLL) circuit 252, and is distributed to the transceivers 200, 202 through a balanced clock tree 254 to ensure that the loopback data 240, 242 of the transceivers 200, 202 and the internal phase-aligned receiver clock signal 212 are phase-aligned and emerged synchronously. Moreover, as the internal phase-aligned receiver clock signal 212 is generated by synchronizing the clock data pattern 250 with the transmitter clock signal 228, all the test data 236, 238 transmitted by the transmitters 206, 208 are also phase-aligned with the internal phase-aligned receiver clock signal 212 and the loopback data 240, 242. As such, the frequency of the internal phase-aligned receiver clock signal 212 may be in the range from about 200 MHz to about 5 GHz to synchronize the loopback data 240, 242.

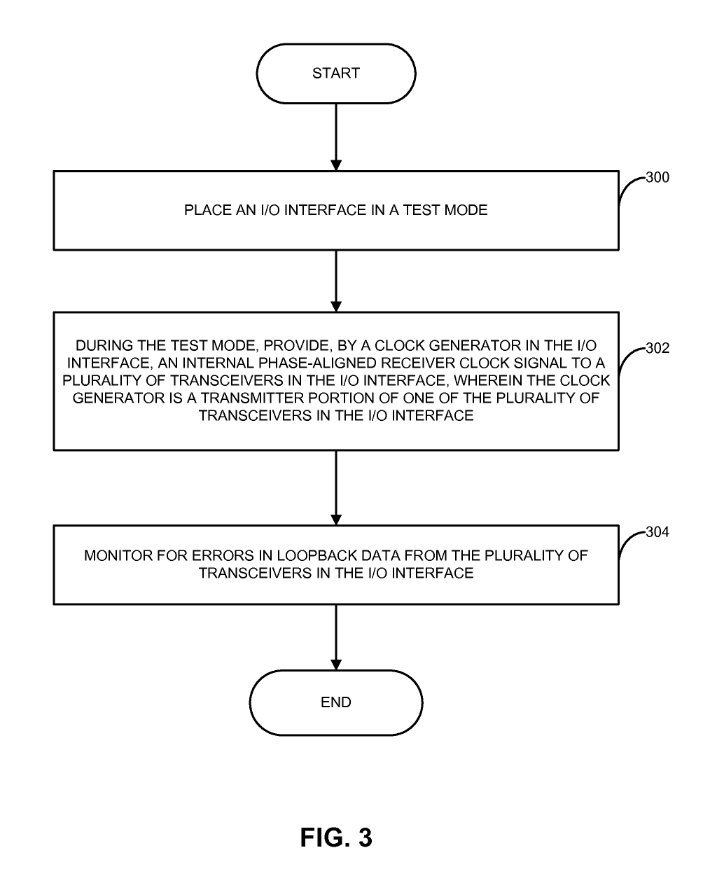

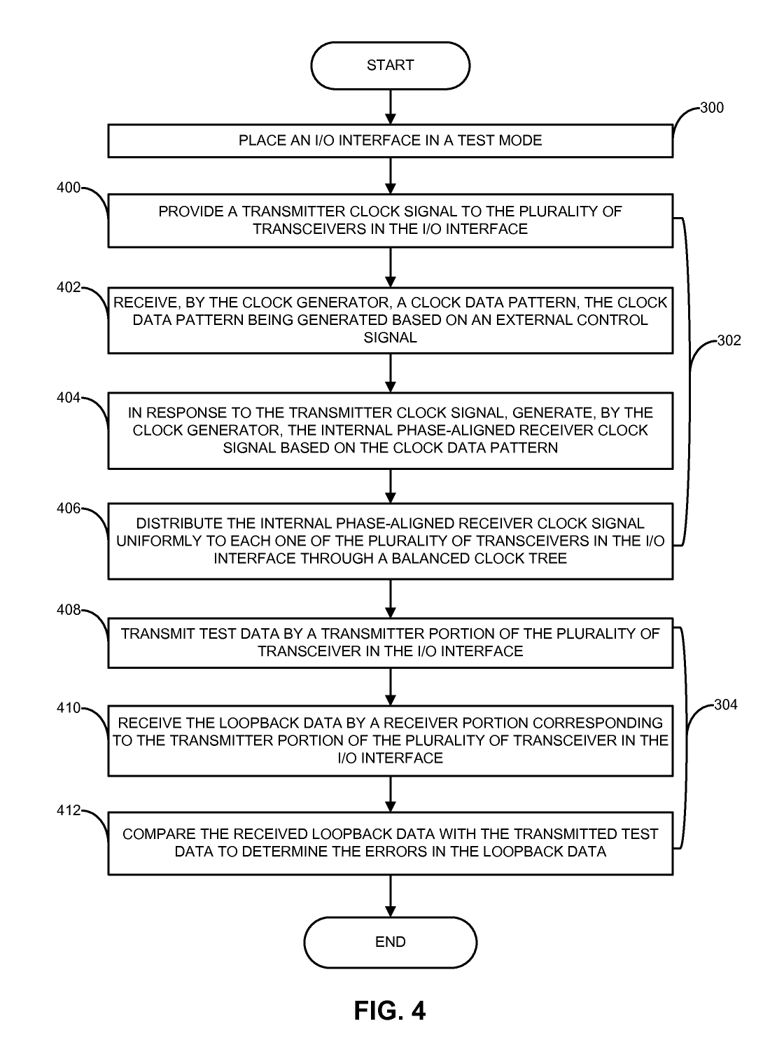

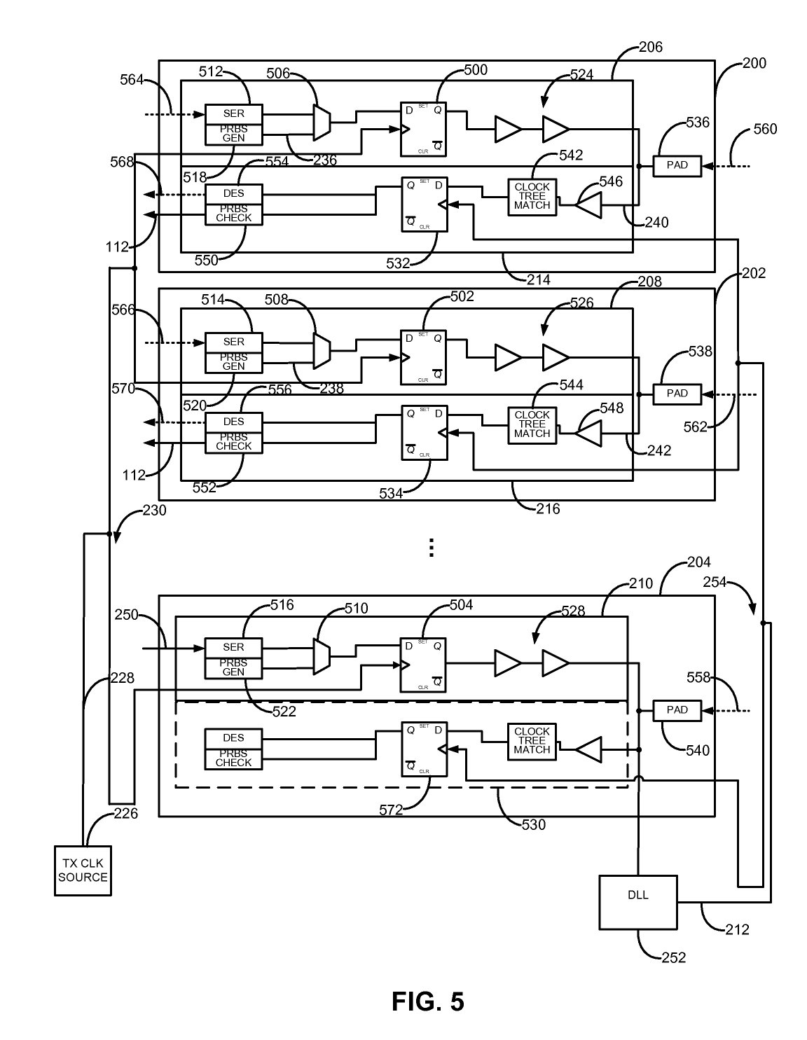

FIG. 3 illustrates one example of a method for testing an integrated circuit including an I/O interface according to one embodiment of the disclosure. It will be described with reference to the above figures. However, any suitable circuit, logic or structure may be employed. In operation, at block 300, the test enabling logic 218, in response to the test mode control signal 220, places the I/O interface 102 in the test mode. During the test mode, at block 302, the clock generator 210 in the I/O interface 102 provides the internal phase-aligned receiver clock signal 212 to the transceivers 200, 202. Eventually, the ATE 108 monitors for errors in loopback data 240, 242 from the transceivers 200, 202 at block 304. The blocks 302 and 304 are further illustrated in FIGS. 4 and 5.

Referring to FIGS. 4 and 5, blocks 400-406 show an example of providing the internal phase-aligned receiver clock signal 212. During the test mode, at block 400, the transmitter clock source 226 provides the transmitter clock signal 228 and distributes the transmitter clock signal 228 to the transmitter 206-210 of all the transceivers 200-204 including the clock generator 210 through the balanced clock tree 230. As shown in FIG. 5, each transmitter 206-210 includes a D-flip flop (DFF) 500-504, and the transmitter clock signal 228 is sent to the clock node of each DFF 500-504. At block 402, in addition to the transmitter clock signal 228, the clock generator 210 also receives the clock data pattern 250 that may be generated by programming the registers 248 by the control signal 110 from the ATE 108. As shown in FIG. 5, each transmitter 206-210 may include a multiplexer 506-510, which has an output operatively connected to the data input node of the DFF 500-504. The input of the multiplexer 506-510 may be selected from a serializer (Ser) 512-516 or a PRBS generator 518-522 depending upon whether the I/O interface 102 is in the normal mode or the test mode. In this example, for the clock generator 210, its PRBS generator 522 has been disabled by the test enabling signal 224 from the test enabling logic 218, and the multiplexer 510 always selects the serializer 516 to transmit the clock data pattern 250 to the data input node of the DFF 504. The clock data pattern 250 may be a “1010 . . . ” repeated binary sequence at a certain frequency generated by the registers 248. The pattern and frequency of the clock data pattern 250 may be controlled by programming the registers 248.

At block 404, in response to the transmitter clock signal 228 received at block 400, the clock generator 210 generates the internal phase-aligned receiver clock signal 212 based on the clock data pattern 250 received at block 402. The clock data pattern 250 is synchronized (e.g. edge-aligned) with the transmitter clock signal 228 by the DFF 504. As shown in FIG. 5, each transmitter 206-210 may include one or more buffers 524-528 to boost the transmitted signal and/or provide impedance transformation if desired. The output signal of the DFF 504 then passes through the buffer 528 and DLL circuit 252 to become the internal phase-aligned receiver clock signal 212. The internal phase-aligned receiver clock signal 212, at block 406, is distributed uniformly to the receiver 214, 216 of each transceiver 200, 202 through the balanced clock tree 254. As shown in FIG. 5, each receiver 214, 216 includes a DFF 532, 534, and the clock node of each DFF 532, 534 receives the internal phase-aligned receiver clock signal 212 generated by the clock generator 210. In one example, the receiver 530 of the transceiver 204 is disabled during the test mode, and thus, the internal phase-aligned receiver clock signal 212 is not transmitted to the transceiver 204. In another example, the receiver 530 is enabled during the test mode to test the circuit of the transceiver 204. In this case, the internal phase-aligned receiver clock signal 212 is also sent to DFF 572 of the receiver 530 for loopback testing of the transceiver 204.

Still referring to FIGS. 4 and 5, blocks 408-412 show an example of monitoring for errors in the loopback data. At block 408, the transmitters 206, 208 transmit the test data 236, 238. As shown in FIG. 5, in this example, during the test mode, the PRBS generators 518, 520 in the transmitters 206, 208 generate PRBS as the test data 236, 238. The multiplexer 506, 508 selects the input from the PRBS generator 518, 520 and sends the test data 236, 238 to the data input node of the DFF 500, 502. As previously noted, each DFF 500, 502 also receives the transmitter clock signal 228 and synchronizes the test data 236, 238 with the transmitter clock signal 228. In this example, the source-synchronous test data 236, 238 outputted from the DFF 500, 502 passes through the buffers 524, 526 to boost the signal strength and/or perform the impedance transformation if desired. Each transceiver 200-204 in FIG. 5 has a common pad 536-540 that operatively connects to both the output of the transmitter 206-210 and the input of its corresponding receiver 214, 216, 530. In the normal mode, as each transmitter 206, 208 and its corresponding receiver 214, 216 do not operate simultaneously, the common pads 536, 538 connect to the second logic (e.g. memory) 106 to either transmit the data from the transmitters 206, 208 to the memory 106 or receive data from the memory 106 to the receivers 214, 216. In this example, during the test mode, in order to perform loopback testing, the output of the transmitters 206, 208 is operatively connected to the input of its corresponding receivers 214, 216. At block 410, the corresponding receivers 214, 216 receive the loopback data 240, 242. The loopback data 240, 242, as shown in FIG. 5, are synchronized with the internal phase-aligned receiver clock signal 212 by the DFF 532, 534. In this example, the loopback data 240, 242 may pass through clock tree match 542, 544 and/or buffers 546, 548 before reaching to the data input node of the DFF 532, 534 in order to delay of the data from the common pad 536, 538 to data input node the DFF 532,534 to match the delay of the internal phase-aligned receiver clock signal 212 to the clock node of the DFF 532, 534, ensuring that the internal phase-aligned receiver clock signal 212 and the loopback data 240, 242 remain properly phase-aligned. Without the clock tree match 542, 544, the internal phase-aligned receiver clock signal 212 may incur additional delay through the balanced clock tree 254 that is not incurred by the loopback data 240, 242, resulting in a phase alignment error between the internal phase-aligned receiver clock signal 212 and the loopback data 240, 242.

As shown in FIG. 5, depending upon the work mode, the output node of the DFF 532, 534 connects to either a PRBS checker 550, 552 or a deserializer (Des) 554, 556 in the receiver 214, 216. At block 412, during the test mode, the loopback data 240, 242 synchronized with the internal phase-aligned receiver clock signal 212 is sent to the PRBS checker 550, 552 to compare the received loopback data 240, 242 with the transmitted test data 236, 238 generated by its corresponding PRBS generator 518, 520. The errors are determined at this block by the PRBS checker 550, 552 and sent to the ATE 108 in the form of error data signals 112. The error data signals 112 have a bit rate that is much lower compared with the test data 236, 238, and thus, can be processed by the ATE 108. As noted previously, in addition to the transceivers 200, 202, the loopback testing may also be performed on the transceiver 204 having the clock generator 210. As shown in FIG. 5, as the transceiver 204 may be any one of the transceivers in the I/O interface 102, the circuit of the transceiver 204 is substantially same as other transceiver 200, 202, and the loopback testing scheme described above can be employed by the transceiver 204 as well. In this case, the transceiver 204 may be tested by comparing the generated clock data pattern 250 with the loopback clock data pattern during the test mode.

Although the processing blocks illustrated in FIG. 4 are illustrated in a particular order, those having ordinary skill in the art will appreciate that the processing can be performed in different orders. In one example, block 400 can be performed after block 402 or performed essentially simultaneously. The clock generator 210 may simultaneously receive the transmitter clock signal 228 and the clock data pattern 250. In another example, block 406 may be performed after block 408 or performed essentially simultaneously. The transmitters 206, 208 may transmit the test data 236, 238 prior to distributing the internal phase-aligned receiver clock signal 212 by the clock generator 210 through the balanced clock tree 254.

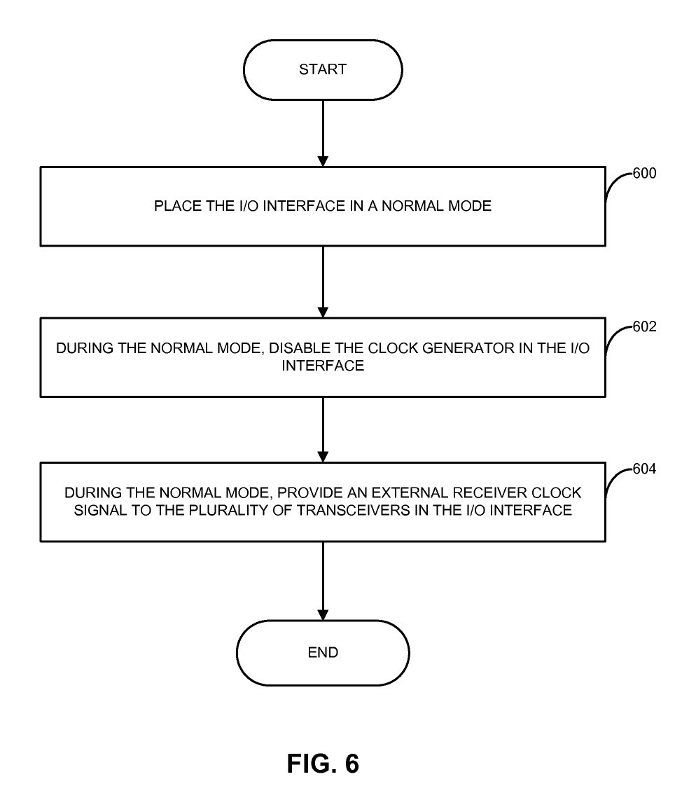

Referring to FIG. 6, the method and apparatus for testing an integrated circuit including an I/O interface may place the I/O interface 102 in a normal mode. In this example, as illustrated in FIG. 2, the test enabling logic 218 at block 600, in response to the de-assertion of the test mode control signal 220 indicating switching from the test mode to the normal mode, sends test enabling signals 222, 224 to the transceivers 200-204 including the clock generator 210. At block 602, in response to the de-assertion of the test enabling signal 222, the clock generator 210 is disabled during the normal mode, and thus, does not provide the internal phase-aligned receiver clock signal 212 to the transceivers 200, 202. Instead, at block 604, an external receiver clock signal 558 is provided, for example, by the memory 106 to the transceiver 204 via the common pad 540. The external receiver clock signal 558 may be distributed to the transceivers 200, 202 through the balanced clock tree 254 to synchronize the data 560, 562 transmitted from the memory 106 to the receivers 214, 216 of the transceivers 200, 202 during the normal mode. During the normal mode, the serializer 512, 514 and deserializer 554, 556 of the transceivers 200, 202 may be used to convert data 564-570 between serial data and parallel interfaces in each direction, if desired, for normal data communication with the core logic 104 and memory 106. In this case, the same transceiver 204, which acts as the clock generator 210 to provide the internal phase-aligned receiver clock signal 212 during the test mode, in response to the de-assertion of the test enabling signal 224, acts as a receiver 530 to receive the external receiver clock signal 558 for normal data communication during the normal mode.

Also, integrated circuit design systems (e.g. work stations) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic and circuits described herein may also be produced as integrated circuits by such systems using the computer readable medium with instructions stored therein. For example, an integrated circuit with the aforedescribed logic and circuits may be created using such integrated circuit fabrication systems. The computer readable medium stores instructions executable by one or more integrated circuit design systems that causes the one or more integrated circuit design systems to design an integrated circuit. The designed integrated circuit includes logic and an I/O interface operatively connected to the logic, as well as other structures as disclosed herein. The I/O interface includes test enabling logic operative to place the I/O interface in a test mode, and a plurality of transceivers. The plurality of transceivers are operative to, during the test mode, output errors in loopback data. The plurality of transceivers include a clock generator that is a transmitter portion of one of the plurality of transceivers and is operative to, during the test mode, provide an internal phase-aligned receiver clock signal to the plurality of transceivers.

Among other advantages, the method and apparatus for testing the integrated circuit including the I/O interface provide the ability to perform the loopback testing of high-speed source-synchronous data. The internal phase-aligned receiver clock signal is generated by the clock generator, which is a transmitter portion of one of the internal transceivers in the I/O interface, and is phase-aligned with the loopback data of the transceivers in the I/O interface. In addition, during the test mode, the ATE only needs to send control signals to the I/O interface and monitor for low-speed error data signals from the I/O interface. As the control and error data signals are low-speed signals, conventional ATE environment is suitable for loopback testing of high-speed source-synchronous data. Furthermore, as the transmitter clock signal and the internal phase-aligned receiver clock signal are distributed to each transceiver through balanced clock trees, a less complex or no additional tuning element is required in the I/O interface to ensure the uniformity of the clock signal received by each transceiver. Accordingly, the proposed techniques can reduce the complexity and cost it takes to perform I/O interface testing at the wafer level or die level by the ATE, which is critical for die stacking. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for testing an integrated circuit, the method comprising:
placing an input/output (I/O) interface in a test mode;
during the test mode, providing, by a clock generator in the I/O interface, an internal phase-aligned receiver clock signal to a plurality of transceivers in the I/O interface, wherein the clock generator is a transmitter portion of one of the plurality of transceivers in the I/O interface; and
monitoring for errors in loopback data from the plurality of transceivers in the I/O interface.

2. The method of claim 1, wherein providing the internal phase-aligned receiver clock signal comprises:
generating, by the clock generator, the internal phase-aligned receiver clock signal; and
distributing the internal phase-aligned receiver clock signal uniformly to each one of the plurality of transceivers in the I/O interface through a balanced clock tree.

3. The method of claim 1, wherein providing the internal phase-aligned receiver clock signal comprises providing a transmitter clock signal to the plurality of transceivers in the I/O interface.

4. The method of claim 3, wherein providing the transmitter clock signal comprises distributing the transmitter clock signal uniformly to each one of the plurality of transceivers in the I/O interface through a balanced clock tree.

5. The method of claim 3, wherein providing the internal phase-aligned receiver clock signal further comprises:
receiving, by the clock generator, a clock data pattern, the clock data pattern being generated based on an external control signal; and
in response to the transmitter clock signal, generating, by the clock generator, the internal phase-aligned receiver clock signal based on the clock data pattern.

6. The method of claim 1, wherein monitoring comprises:
transmitting test data by a transmitter portion of the plurality of transceivers in the I/O interface;
receiving the loopback data by a receiver portion corresponding to the transmitter portion of the plurality of transceivers in the I/O interface; and
comparing the received loopback data with the transmitted test data to determine the errors in the loopback data.

7. The method of claim 1, wherein the phase of the internal phase-aligned receiver clock signal is aligned with the loopback data of the plurality of transceivers in the I/O interface.

8. The method of claim 1, wherein the frequency of the internal phase-aligned receiver clock signal is above about 200 MHz.

9. The method of claim 1 further comprising:
placing the I/O interface in a normal mode;
during the normal mode, disabling the clock generator in the I/O interface; and
during the normal mode, providing an external receiver clock signal to the plurality of transceivers in the I/O interface.

10. An integrated circuit comprising:
logic; and
an I/O interface operatively connected to the logic, the I/O interface comprising:
test enabling logic operative to place the I/O interface in a test mode; and
a plurality of transceivers operative to, during the test mode, output errors in loopback data, the plurality of transceivers comprising:
a clock generator operative to, during the test mode, provide an internal phase-aligned receiver clock signal to the plurality of transceivers, wherein the clock generator is a transmitter portion of one of the plurality of transceivers.

11. The integrated circuit of claim 10, wherein the clock generator is further operative to:
generate the internal phase-aligned receiver clock signal; and
distribute the internal phase-aligned receiver clock signal uniformly to each one of the plurality of transceivers through a balanced clock tree.

12. The integrated circuit of claim 10, wherein the I/O interface further comprises a transmitter clock source operative to provide a transmitter clock signal to the plurality of transceivers.

13. The integrated circuit of claim 12, wherein the transmitter clock source is further operative to distribute the transmitter clock signal uniformly to each one of the plurality of transceivers through a balanced clock tree.

14. The integrated circuit of claim 12, wherein the clock generator is further operative to:
receive a clock data pattern, the clock data pattern being generated based on an external control signal; and
in response to the transmitter clock signal, generate the internal phase-aligned receiver clock signal based on the clock data pattern.

15. The integrated circuit of claim 10, wherein each one of the plurality of transceivers comprises:
a transmitter portion operative to transmit test data;
a receiver portion corresponding to the transmitter portion, operative to receive the loopback data; and
a checker, operatively connected to the receiver portion, operative to compare the received loopback data with the transmitted test data to determine the errors in the loopback data.

16. The integrated circuit of claim 10, wherein the phase of the internal phase-aligned receiver clock signal is aligned with the loopback data of the plurality of transceivers.

17. The integrated circuit of claim 10, wherein the frequency of the internal-phase aligned receiver clock signal is above about 200 MHz.

18. The integrated circuit of claim 10, wherein the test enabling logic is further operative to place the I/O interface in a normal mode; and
wherein during the normal mode, the clock generator is operative to be disabled; and the logic is operative to provide an external receiver clock signal to the plurality of transceivers.

19. A system for testing an I/O interface, the system comprising an automatic test equipment operative to:
provide an external control signal to the I/O interface to generate a clock data pattern; and
monitor for errors in loopback data from a plurality of transceivers in the I/O interface.

20. The system of claim 19 comprising the I/O interface operative to:
in response to the external control signal from the automatic test equipment, generate an internal phase-aligned receiver clock signal based on the clock data pattern;
distribute the internal phase-aligned receiver clock signal uniformly to each one of the plurality of transceivers in the I/O interface through a balanced clock tree; and
output the errors in the loopback data to the automatic test equipment.

21. A computer readable medium storing instructions executable by one or more integrated circuit design systems that causes the one or more integrated circuit design systems to design an integrated circuit comprising:
logic; and
an I/O interface operatively connected to the logic, the I/O interface comprising:
test enabling logic operative to place the I/O interface in a test mode; and
a plurality of transceivers operative to, during the test mode, output errors in loopback data, the plurality of transceivers comprising:
a clock generator operative to, during the test mode, provide an internal phase-aligned receiver clock signal to the plurality of transceivers, wherein the clock generator is a transmitter portion of one of the plurality of transceivers.
